(19) United States
(12) Patent Application Publication
(10) Pub. No.: US 2025/0085116 A1
(43) Pub. Date: Mar. 13, 2025

(54) IDENTIFYING CHARACTERISTICS OF A SCENE, WITH HIGH LEVEL OF SAFETY INTEGRITY, BY COMPARING SENSOR DATA WITH AN EXPECTATION

(71) Applicant: Robert Bosch GmbH, Stuttgart (DE)

(72) Inventors: Michael David Warren, Tuebingen (DE); Oliver Lange, Hemmingen (DE)

(21) Appl. No.: 18/727,414

(22) PCT Filed: Dec. 7, 2022
(86) PCT No.: PCT/EP2022/084697

§ 371 Date: Jul. 9, 2024

(30) Foreign Application Priority Data
Jan. 10, 2022 (DE) 10 2022 200 147.8

(51) Int. Cl. G01C 21/30; G01S 13/86; G01S 13/89; G06V 20/56

(52) U.S. Cl. CPC G01C 21/30; G01S 13/865; G01S 13/867; G01S 13/89; G06V 20/56

(57) ABSTRACT

A method for evaluating spatially resolved actual sensor data acquired using at least one sensor. The method includes: ascertaining a location and an orientation of the sensor at the time of acquiring the sensor data; retrieving a spatially resolved expectation from a spatially resolved map on the basis of the location and the orientation of the sensor; checking to what extent the actual sensor data are consistent with the expectation; at least with respect to the locations for which the actual sensor data are consistent with the expectation, determining that the scene observed by the sensor has a characteristic stored in the map in conjunction with the expectation.

### FIELD

The present invention relates to identifying characteristics of a scene observed by means of at least one sensor, for example for the at least partially autonomous control of a vehicle or robot.

### BACKGROUND INFORMATION

Driving assistance systems and systems for the at least partially automated guidance of vehicles or robots sense the environment of the vehicle or robot by means of one or more sensors and ascertain therefrom a plan for the future behavior of the vehicle or robot. Neural networks are frequently used to ascertain such a plan, or an environmental representation as a pre-product for the plan. German Patent Application No. DE 10 2018 008 685 A1 describes a method for training a neural network for determining a path prediction for a vehicle.

### SUMMARY

The present invention provides a method for evaluating spatially resolved actual sensor data acquired by means of at least one sensor. In particular, this sensor may, for example, be a mobile sensor carried by a person, a robot or any land vehicle, watercraft or aircraft. However, the sensor may also, for example, be a stationary sensor that monitors a busy intersection, for example. The term “spatially resolved actual sensor data” is understood to mean any sensor data that are assigned to specific locations during their capture. For example, radar data and lidar data can be present as point clouds of measured values that are assigned to points in three-dimensional space from which the respectively used scanning radiation was reflected. Images assign intensity values to the pixels of the sensor used to sense them, the pixels usually being arranged in a regular grid. Depending on the perspective from which the image was acquired, and the optics used, each pixel in turn corresponds to a location in space from which the respective incident light comes.

According to an example embodiment of the present invention, a location and an orientation of the sensor are ascertained at the time the sensor data are acquired. This process is also called “registration” or “localization” of the sensor in the physical world. For this purpose, any system can be used individually or in combination. For example, navigation systems on the basis of radio signals emitted by satellites or terrestrial stations can be used. Alternatively or in combination, an inertial navigation system may be used, for example. If the sensor is a stationary sensor, its registration or localization is particularly simple because its location and its orientation are known in advance.

According to an example embodiment of the present invention, on the basis of the location and the orientation of the sensor, a spatially resolved expectation for the actual sensor data is retrieved from a spatially resolved map. This expectation is stored in the spatially resolved map in association with at least one characteristic of the observed scene. If the scene observed by means of at least one sensor actually has this characteristic stored in the map, it is expected that the actual sensor data are consistent with the expectation retrieved from the spatially resolved map.

Conversely, this means that, if the actual sensor data are consistent with the expectation, the characteristic stored in the map is also present. Checking whether this characteristic exists is precisely the aim of the method.

It is therefore checked to what extent the actual sensor data are consistent with the expectation. At least with respect to the locations for which this is the case, it is determined that the scene observed by means of the at least one sensor has the characteristic stored in the map in conjunction with the expectation.

The expectation stored in the map represents a “fingerprint” of the scene observed by means of the sensor, so to speak. This “fingerprint” can comprise any characteristics that can be evaluated from sensor data, such as a geometry, texturing, or a multispectral response. Basic physical characteristics, such as magnetic resonance, may, for example, also come into consideration as characteristics that can be evaluated.

The sensor data may, for example, in particular be sensor data acquired by a sensor on a vehicle or robot. The vehicle may be any land vehicle, watercraft or aircraft. An important application of the method in the context of controlling vehicles and robots is to check which locations can be freely accessed by the vehicle or robot. For this purpose, the characteristic stored in the map can include a statement as to the extent to which locations to which the expectation relates can be freely accessed by the vehicle or robot. In the same way, the method can also be used with mobile sensors that are carried by a person, for example in order to signal the accessible areas to a blind person.

This can be illustrated by a simple example in which camera images are used as sensor data. Camera images are then included in the map, and it is in each case labeled in these images which areas are freely accessible by the vehicle and which are not. If, during the trip of the vehicle, certain areas are recognized at the correct locations on the basis of the camera images currently acquired by the vehicle, there is a guarantee that the statement stored in the map for these areas as to whether they are freely accessible by the vehicle or not corresponds to the current state of these areas. If, for example, there is an obstacle at a certain point in the camera images acquired during the trip and if this obstacle deviates with respect to at least one characteristic, such as its visual appearance or its geometry, from the same characteristic of the image stored in the map, this object can be safely identified.

In this way, an open classification task as to whether an area is freely accessible (or has any other characteristic important for trip planning) can thus be reduced to a comparison with known information stored in the map. It has been found that the identification as to which areas are freely accessible can be carried out with considerably better safety integrity as a result. If a spatial area at a certain location produces the same or at least similar sensor data as those stored in the map as an expectation, it necessarily follows that the area has the same occupancy with objects in comparison to its state when the map was created (i.e., for example, it is free of objects and thus accessible) and that there are also no further objects between the sensor and this area. Any unplanned object in the area in question or in the line of sight between the sensor and the area destroys the agreement between actual sensor data and expectation and thus results in the area no longer being identified as freely accessible.

In comparison to an open classification task, such as those solved by means of neural networks, for example, this has the advantage that a not freely accessible area is identified as not freely accessible even if the reason for its lack of accessibility is extremely unusual and therefore is not included in the training data used to train the neural network. Events that are too unlikely to be included in training data are also referred to as “long tails.”

For example, very unusual objects, such as furniture, large electrical appliances, skis or bicycles, are sometimes lost on highways because the load is inadequately secured. The appearance of such objects on the roadway on which the ego vehicle drives is a highly dangerous situation and fortunately occurs only rarely. However, this also means that when collecting real data for training neural networks during test drives, such examples are highly unlikely to occur. Deliberately recreating such situations in public streets is not practical.

The same applies to the dreaded “blow-ups” that suddenly occur during heat waves and in which the concrete road of the highway bulges or breaks open. Such situations cannot be trained either, since the moment a “blow-up” appears in the camera image, an accident can hardly be prevented.

In addition, identifying freely accessible areas by recognizing them in the map is also not susceptible to deliberate manipulation. By maliciously introducing interference patterns, many image classifiers based on neural networks can be caused to output an incorrect classification. For example, a stop sign can be manipulated by attaching a seemingly inconspicuous sticker so that it is classified as a “70 km/h” sign. Experiments have already shown that by attaching a film with an inconspicuous semi-transparent dot pattern to a camera lens, the ability of the downstream image classifier to identify pedestrians can be completely eliminated. The pedestrians were classified as freely accessible space.

An attempt at such manipulation is either completely ignored within the framework of the method presented here or, in the worst case, leads to an area that is actually freely accessible is not identified as freely accessible. Any unexpected problem will therefore result in the area in question being avoided instead of being driven through (“fail-safe”).

Furthermore, the expectation can already be used to determine an upper limit for the areas that can be identified as freely accessible. The recognition of an area in the expectation can only trigger an assessment of this area as freely accessible if the area was marked as freely accessible in the context of the expectation. Areas that have not been marked as freely accessible here, such as concrete barriers or trees at the edge of the road, can never be identified as freely accessible.

The significantly improved safety integrity when ascertaining characteristics of the scene observed by means of the at least one sensor has the result that the control of a vehicle or robot according to the characteristics thus ascertained is more likely to be appropriate to the particular situation. It is therefore advantageous to ascertain a control signal for the vehicle or robot by using the determination as to the locations for which the scene observed by the sensor has the characteristic stored in the map in conjunction with the expectation. The vehicle or robot is controlled using this control signal so that the driving dynamics of the vehicle or robot are influenced according to the control signal.

The comparison of the actual sensor data with the expectation is not limited to a 1:1 recognition. Instead, a tolerance or, for example, an abstraction into certain features can be provided in any form for this recognition. For example, even two camera images of one and the same scene that are acquired immediately one after the other are generally not completely identical.

In a further, particularly advantageous embodiment of the present invention, the actual sensor data and the expectation are converted into a common spatial reference system and/or into a common workspace. The actual sensor data are compared with the expectation in this reference system or workspace. In this way, sensor data and expectations that were acquired by means of different modalities can also be compared with one another. For example, the expectation can include
a spatially resolved three-dimensional geometry, and/or
texturing, and/or
a reflectance amplitude, and/or
a multispectral response, and/or
a magnetic resonance
   of the scene observed by the at least one sensor. Such a geometry can, for example, be ascertained on the basis of image acquisitions. Such a geometry can be easily labeled with regard to freely accessible areas or other characteristics of the scene. It can then be checked, for example, to what extent radar data or lidar data are consistent with this geometry.

In addition to radar sensors and lidar sensors, stereoscopically arranged cameras or multi-camera systems, for example, in particular also come into consideration for capturing the sensor data. Such camera arrangements also provide depth information, which can be checked against the geometry of the expectation. Moving monocular cameras are also possible for generating depth information. Furthermore, multispectral cameras, time-of-flight (ToF) sensors, cameras with pixels responding on the basis of events, ultrasonic sensors or even magnetic sensors may, for example, also be used.

For example, the check as to whether sensor data acquired by means of a stereoscopic camera arrangement are consistent with the three-dimensional geometry of the expectation may comprise a check of the so-called stereo hypothesis. This check is based on the geometry of the scene coupling the images provided by both cameras of the stereoscopic camera arrangement, to one another. If one of the images and the geometry of the expectation are present, the other image is thus at least largely determined.

Therefore, an image provided by the first camera of the camera arrangement can be transformed, on the basis of the geometry of the expectation, into an expectation for the image provided by the second camera of the camera arrangement. It can then be checked to what extent this expectation is consistent with an image actually provided by the second camera of the camera arrangement. In particular, the transformation may, for example, comprise distorting the image provided by the first camera on the basis of the geometry so that it fits with the perspective of the second camera.

For comparing the image provided by the second camera with the expectation, features can, for example, in particular be extracted, respectively, from the image provided by the second camera on the one hand, and from the expectation for this image on the other hand. These features can then be compared with one another. This abstraction into features can smooth out insignificant differences for the comparison, for example with regard to colors or lighting.

For example, for each feature to be compared, a binary decision can in particular be made as to whether a feature from the image is consistent with the corresponding feature from the expectation for this image. From the number of features that are consistent with one another, a degree of agreement between the image and the expectation can then be ascertained. For example, a Hamming distance can thus be ascertained between the examined combinations of features, which is the larger, the more features of the image on the one hand and of the expectation on the other hand are inconsistent with one another.

In a further advantageous embodiment of the present invention, it is additionally checked to what extent a predetermined test image, which does not show the scene observed by the sensor, is consistent with the expectation for the image provided by the second camera of the camera arrangement. This degree of agreement is then used as the noise level for the ascertained agreement between the image provided by the second camera of the camera arrangement and the expectation for this image. In this way, a signal-to-noise ratio can be ascertained for the agreement of the image provided by the second camera, with the expectation for this image. This signal-to-noise ratio is more meaningful than the agreement alone. For example, the meaningfulness of the image may be reduced because large parts thereof have become saturated due to overexposure or underexposure.

The method can also be generalized in that actual sensor data are acquired by means a plurality of sensor modalities and the results are subsequently merged. In a further advantageous embodiment of the present invention, for actual sensor data acquired by means of a plurality of different sensors, it is therefore checked, respectively and separately, for which locations these actual sensor data are consistent, respectively, with the expectation retrieved from the map. Only for the locations for which the actual sensor data of all sensors are consistent, respectively, with the expectation, it is then determined overall that the actual sensor data overall are consistent with the expectation. For example, an area is only assessed to be freely accessible to a vehicle or robot if it has been identified as freely accessible on the basis of the sensor data, provided by a plurality of sensors of different sensor modalities (such as lidar and stereoscopic camera), independently of one another.

For example, it can first be checked to what extent current lidar data are consistent with a geometry of the scene that is stored in the map. In parallel, it can be checked, for example, to what extent images provided by a stereoscopic camera arrangement are consistent with this geometry. For this purpose, the geometry can, for example, be transformed into the reference system of the first camera of the camera arrangement. The stereo hypothesis can then be checked, as described above, by transforming the image provided by the first camera of the camera arrangement, on the basis of the geometry into an expectation for the image provided by the second camera of the camera arrangement, and by comparing this expectation with the image actually provided by the second camera. Only for locations for which both the lidar data and the images provided by the stereoscopic camera arrangement are consistent, respectively, with the geometry stored as an expectation in the map, it can then be determined that these locations have the desired characteristic (for example, the free accessibility of these locations) according to the map.

In a further advantageous embodiment of the present invention, actual sensor data, the agreement of which with the expectation is checked, are checked for plausibility against actual sensor data acquired by means of a further sensor. Agreement with the expectation is then determined or maintained only with respect to the locations for which this plausibility check is positive.

Only one comparison instead of two comparisons between a sensor modality and the expectation thus takes place. Furthermore, the two sensor modalities are compared with one another. For example, an area can only be declared to be freely accessible if, on the one hand, it turns out to be freely accessible on the basis of the comparison of lidar data to the geometry stored as an expectation, and if, on the other hand, the lidar data in this area are consistent with images provided by a stereoscopic camera arrangement.

In a further advantageous embodiment of the present invention, an ascertained location and/or an ascertained orientation is optimized with the aim of maximizing the agreement of the actual sensor data with the expectation. As explained above, comparing actual sensor data with the expectation depends on retrieving the expectation for the correct location and the correct orientation of the sensor from the map. Only then can the expectation be correctly recognized on the basis of the current actual sensor data. However, every method for determining the location and the orientation has limited accuracy. If the agreement between the sensor data and the expectation can, for example, be significantly improved by an additional shift of the ascertained location of the sensor and/or by an additional tilting or rotation of the ascertained orientation of this sensor, this indicates that the previously ascertained location or the previously ascertained orientation of the sensor was not entirely correct. Alternatively or in combination, any other technique can be used to convert the actual sensor data and the map into a common reference system.

According to an example embodiment of the present invention, the method can in particular be wholly or partially computer-implemented. For this reason, the present invention also relates to a computer program comprising machine-readable instructions which, when executed on one or more computers, cause said computer(s) to carry out the method of the present invention described above. In this sense, control devices for vehicles and embedded systems for technical devices, which are also capable of executing machine-readable instructions, are also to be regarded as computers.

The present invention also relates to a machine-readable data carrier and/or to a download product comprising the computer program of the present invention. A download product is a digital product that can be transmitted via a data network, i.e., can be downloaded by a user of the data network, and can, for example, be offered for immediate download in an online shop.

Furthermore, a computer can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for evaluating spatially resolved actual sensor data 2, according to the present invention.

FIG. 2 shows an exemplary application of the method 100 of the present invention to a street scene.

### DETAILED DESCRIPTION OF EXAMPLE EMBODIMENTS

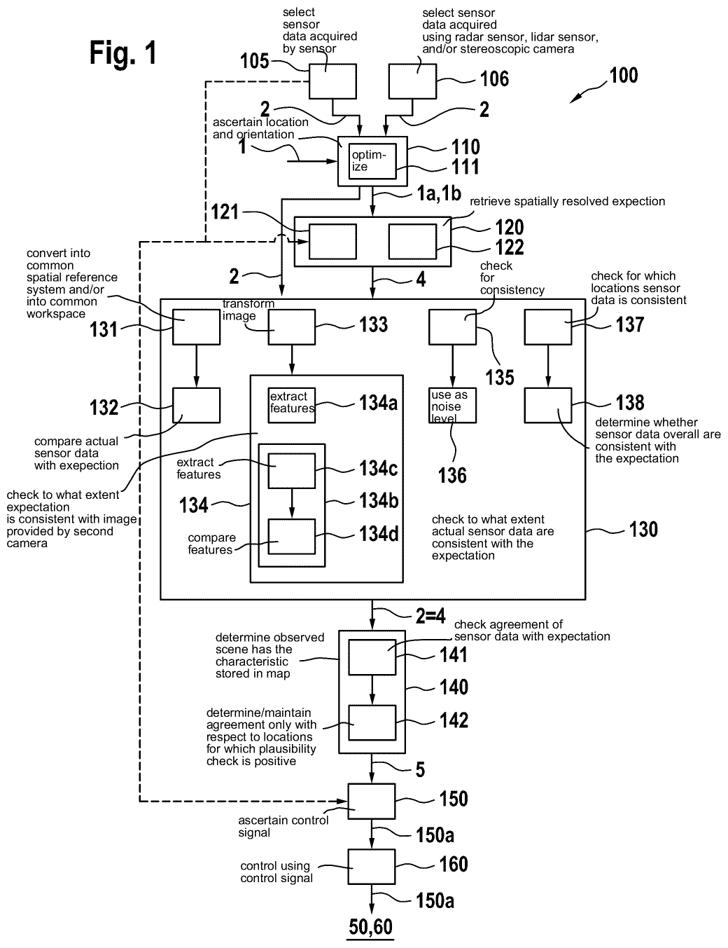

FIG. 1 is a schematic flow diagram of an exemplary embodiment of the method 100 for evaluating spatially resolved actual sensor data 2 with regard to the locations at which the scene observed by a sensor 1 has an interesting characteristic 5.

In step 105, sensor data 2 acquired by a sensor 1 on a vehicle 50 or robot 60 may be selected.

In step 106, sensor data 2 acquired by means of a radar sensor, a lidar sensor, and/or a stereoscopic camera arrangement may be selected.

In step 110, a location 1a and an orientation 1b of the sensor 1 at the time of acquiring the sensor data 2 are ascertained.

In step 120, a spatially resolved expectation 4 is retrieved from a spatially resolved map 3 on the basis of the location 1a and the orientation 1b of the sensor 1. Furthermore, an interesting characteristic 5 is also stored with spatial resolution in the map 3. The characteristic 5 is coupled with the expectation 4 in that, assuming that the scene observed by the sensor 1 has the characteristic 5 from a certain location, the actual sensor data 2 should be consistent with the expectation 4.

In step 130, it is checked to what extent the actual sensor data 2 are consistent with the expectation 4.

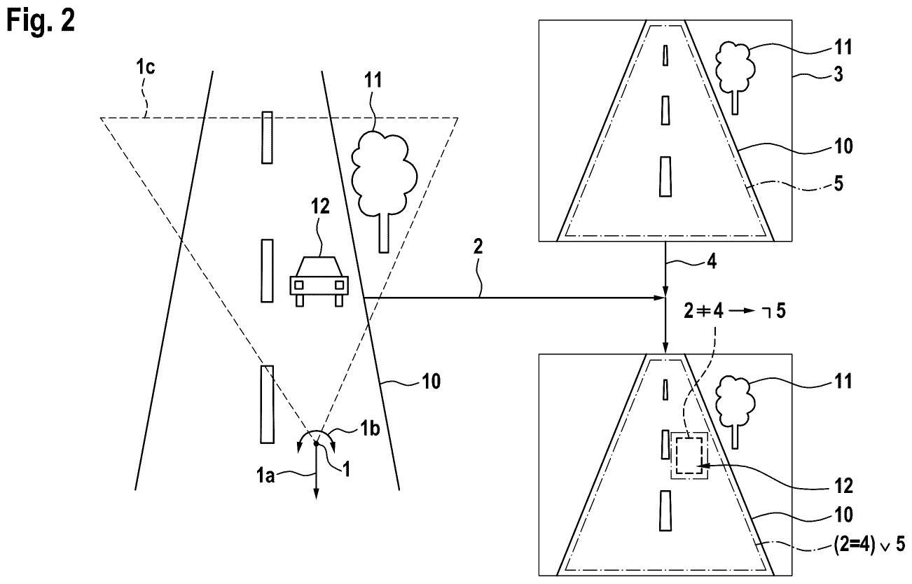

In step 140, at least with respect to the locations for which the actual sensor data 2 are consistent with the expectation 4, it is determined that the scene observed by the sensor 1 has the characteristic 5 stored in the map 3 in conjunction with the expectation 4. This is illustrated in FIG. 2 using an example.

In step 150, a control signal 150a for the vehicle 50 or robot 60 is ascertained by using the determination as to the locations for which the scene observed by the sensor 1 has the characteristic 5 stored in the map 3 in conjunction with the expectation 4.

In step 160, the vehicle 50 or robot 60 is controlled using this control signal 150a so that the driving dynamics of the vehicle 50 or robot 60 are influenced according to the control signal 150a.

According to block 111, an ascertained location 1a and/or an ascertained orientation 1b can be optimized with the aim of maximizing the agreement of the actual sensor data 2 with the expectation 4.

According to block 121, the characteristic 5 stored in the map 3 can, for example, in particular include a statement as to the extent to which locations to which the expectation 4 relates can be freely accessed by the vehicle 50 or robot 60.

According to block 122, the expectation 4 can, for example, in particular include a spatially resolved three-dimensional geometry of the scene observed by the sensor 1.

According to block 131, the actual sensor data 2 and the expectation 4 can be converted into a common spatial reference system and/or into a common workspace. According to block 132, the actual sensor data 2 can then be compared with the expectation 4 in this reference system or workspace.

According to block 133, for checking as to whether sensor data 2 acquired by means of a stereoscopic camera arrangement are consistent with the three-dimensional geometry of the expectation 4, an image provided by the first camera of this camera arrangement can be transformed, on the basis of the geometry of the expectation 4, into an expectation for the image provided by the second camera of the camera arrangement.

According to block 134, it can then be checked to what extent this expectation is consistent with an image actually provided by the second camera of the camera arrangement.

This check in turn may include, according to block 134a, extracting features, respectively, from the image provided by the second camera on the one hand, and from the expectation for this image on the other hand and, according to block 134b, comparing these features with one another.

This comparison in turn may include, according to block 134c, making a binary decision for each feature as to whether a feature from the image is consistent with the corresponding feature from the expectation for this image and, according to block 134d, ascertaining a degree of agreement between the image and the expectation from the number of features that are consistent with one another.

According to block 135, it can additionally be checked to what extent a predetermined test image, which does not show the scene observed by the sensor 1, is consistent with the expectation for the image provided by the second camera of the camera arrangement. According to block 136, this degree of agreement can then be used as the noise level for the ascertained agreement between the image provided by the second camera of the camera arrangement and the expectation for this image.

According to block 137, for actual sensor data 2 acquired by means of a plurality of different sensors 1, it can be checked, respectively and separately, for which locations these actual sensor data 1 are consistent, respectively, with the expectation 4 retrieved from the map 3. According to block 138, only for the locations for which the actual sensor data 2 of all sensors 1 are consistent, respectively, with the expectation, it can then be determined overall that the actual sensor data 2 overall are consistent with the expectation 4.

According to block 141, actual sensor data 2, the agreement of which with the expectation 4 is checked, are checked for plausibility against actual sensor data 2 acquired by means of a further sensor 1. According to block 142, agreement with the expectation 4 can then be determined or maintained only with respect to the locations for which this plausibility check is positive.

FIG. 2 shows an exemplary application of the method 100 to a street scene.

In this example, the sensor 1 is carried by a vehicle not shown. From a perspective determined by the location 1a and the orientation 1b of the sensor 1, the sensor 1 captures actual sensor data 2 within its detection range 1c. In the example shown in FIG. 2, the scene includes a road 10 with a preceding vehicle 12 and a tree 11 at the edge of the road.

The spatially resolved map 3 likewise includes the road 10 and the tree 11, but the preceding vehicle 12 is missing. The interesting characteristic 5, namely, that the area is freely accessible, is stored for this area of the road 10.

The view and/or geometry of the scene that is/are contained in the map 3 is/are compared as expectation 4 with the actual sensor data 2. In the process, it is largely determined for the region of the road 10 that the actual sensor data 2 are consistent with the expectation 4 and, in conjunction with the expectation 4, the characteristic 5 that the region is a freely accessible region is at the same time stored in the map 3. Accordingly, this region is deemed to be freely accessible.

The only exception is the area with the preceding vehicle 12. Since this vehicle is missing in the map 3, the actual sensor data 2 deviate from the expectation 4. Accordingly, the area with the preceding vehicle 12 is not deemed to be freely accessible.

1-17. (canceled)

18. A method for evaluating spatially resolved actual sensor data acquired using at least one sensor, the method comprising the following steps:
ascertaining a location and an orientation of the sensor at a time of acquiring the actual sensor data;
retrieving a spatially resolved expectation from a spatially resolved map based on the location and the orientation of the sensor;
checking to what extent the actual sensor data are consistent with the expectation; and
at least with respect to locations for which the actual sensor data are consistent with the expectation, determining that a scene observed by the sensor has a characteristic stored in the spatially resolved map in conjunction with the expectation.

19. The method according to claim 18, wherein the sensor is a sensor on a vehicle or a sensor on a robot.

20. The method according to claim 19, wherein the characteristic stored in the spatially resolved map includes a statement as to an extent to which locations to which the expectation relates can be freely accessed by the vehicle or the robot.

21. The method according to one of claim 19, wherein:
a control signal for the vehicle or the robot is ascertained by using the determination as to the locations for which the scene observed by the sensor has the characteristic stored in the spatially resolved map in conjunction with the expectation, and
the vehicle or the robot is controlled using the control signal so that driving dynamics of the vehicle or the robot are influenced according to the control signal.

22. The method according to claim 18, wherein the actual sensor data and the expectation are converted into a common spatial reference system and/or into a common workspace, and wherein the actual sensor data are compared with the expectation in the reference system or the workspace.

23. The method according to claim 18, wherein the expectation includes at least one of the following:
a spatially resolved three-dimensional geometry of the scene observed by the sensor,
texturing of the scene observed by the sensor,
a reflectance amplitude of the scene observed by the sensor,
a multispectral response of the scene observed by the sensor,
a magnetic resonance of the scene observed by the sensor.

24. The method according to claim 18, wherein the at least one sensor includes at least one radar sensor and/or at least one lidar sensor and/or at least one camera.

25. The method according to 18, wherein the at least one sensor includes a stereoscopic camera arrangement, and wherein the expectation includes a spatially resolved three-dimensional geometry of the scene observed by the stereoscopic camera arrangement, and the checking including checking includes:
transforming an image provided by the first camera of the stereoscopic camera arrangement, based on the spatially resolved three-dimensional geometry of the expectation, into an expectation for an image provided by the second camera of the camera arrangement, and
checking to what extent the expectation for the image provided by the second camera is consistent with an image actually provided by the second camera of the stereoscopic camera arrangement.

26. The method according to claim 25, wherein:
features are extracted, respectively, from the image actually provided by the second camera on the one hand, and from the expectation for the image provided by the second camera on the other hand, and
the features are compared with one another.

27. The method according to claim 26, wherein:
a binary decision is made as to whether a feature from the image actually provided by the second camera is consistent with a corresponding feature from the expectation for the image provided by the second camera; and
from a number of features that are consistent with one another, a degree of agreement between the image actually provided by the second camera and the expectation for the image provided by the second camera.

28. The method according to claim 25, wherein:
it is additionally checked to what extent a predetermined test image, which does not show the scene observed by the sensor, is consistent with the expectation for the image provided by the second camera, and
a degree of agreement is used as a noise level for an ascertained agreement between the image provided by the second camera of the camera arrangement and the expectation for this image is ascertained.

29. The method according to claim 18, wherein:
the at least one sensor includes a plurality of different sensors, and it is checked, respectively and separately, for which locations the actual sensor data are consistent, respectively, with the expectation retrieved from the spatially resolved map, and
only for those locations for which the actual sensor data of all of the plurality of different sensors are consistent, respectively, with the expectation, it is determined overall that the actual sensor data overall are consistent with the expectation.

30. The method according to claim 18, wherein:
the actual sensor data, an agreement of which with the expectation is checked, are checked for plausibility against actual sensor data acquired by a further sensor, and
agreement with the expectation is determined or maintained only with respect to those locations for which the plausibility check is positive.

31. The method according to claim 18, wherein an ascertained location and/or an ascertained orientation are optimized with an aim of maximizing agreement of the actual sensor data with the expectation.

32. A non-transitory machine-readable data carrier on which is stored a computer program for evaluating spatially resolved actual sensor data acquired using at least one sensor, the computer program, when executed by a computer, causing the computer to perform the following steps:
ascertaining a location and an orientation of the sensor at a time of acquiring the actual sensor data;
retrieving a spatially resolved expectation from a spatially resolved map based on the location and the orientation of the sensor;
checking to what extent the actual sensor data are consistent with the expectation; and
at least with respect to locations for which the actual sensor data are consistent with the expectation, determining that a scene observed by the sensor has a characteristic stored in the spatially resolved map in conjunction with the expectation.

33. One or more computers comprising a non-transitory machine-readable data carrier on which is stored a computer program for evaluating spatially resolved actual sensor data acquired using at least one sensor, the computer program, when executed by the one or more computers, causing the one or more computers to perform the following steps:
ascertaining a location and an orientation of the sensor at a time of acquiring the actual sensor data;
retrieving a spatially resolved expectation from a spatially resolved map based on the location and the orientation of the sensor;
checking to what extent the actual sensor data are consistent with the expectation; and
at least with respect to locations for which the actual sensor data are consistent with the expectation, determining that a scene observed by the sensor has a characteristic stored in the spatially resolved map in conjunction with the expectation.
